(19) United States
(12) Patent Application Publication
(10) Pub. No.: US 2025/0266479 A1
(43) Pub. Date: Aug. 21, 2025

(54) FUEL CELL POWER GENERATION CONTROL SYSTEM

(71) Applicant: HONDA MOTOR CO., LTD., Tokyo (JP)

(72) Inventor: Yizhi ZHANG, Saitama (JP)

(21) Appl. No.: 19/039,167

(22) Filed: Jan. 28, 2025

(30) Foreign Application Priority Data
Feb. 15, 2024 (JP) 2024-021415

(51) Int. Cl. H01M 8/04858; H01M 8/04537

(52) U.S. Cl. CPC H01M 8/04932; H01M 8/04611

(57) ABSTRACT

A fuel cell power generation control system includes: a plurality of fuel cell systems each including a fuel cell capable of generating electric power by a reaction of a fuel gas and an oxidant gas; a required power generation amount acquisition unit configured to acquire a required power generation amount for the plurality of fuel cell systems; a limit value acquisition unit configured to acquire an output limit value for the fuel cell of each of the plurality of fuel cell systems; and a power generation amount determination unit configured to determine a target power generation amount for each of the plurality of fuel cell systems, wherein the power generation amount determination unit determines the target power generation amount based on the required power generation amount and the output limit value.

### BACKGROUND

### Technical Field

The present invention relates to a fuel cell power generation control system for a plurality of fuel cell systems, the fuel cell power generation control system being able to efficiently determine a target power generation amount of each of the fuel cell systems with a small calculation load even at the time of failure.

### Related Art

In these years, research and development on a fuel cell that contributes to energy efficiency are conducted such that more people are able to access energy that is affordable, reliable, sustainable, and advanced.

In a fuel cell vehicle using a fuel cell as one of power sources, there is a fuel cell vehicle in which a plurality of fuel cell systems are mounted, and the plurality of fuel cell systems are simultaneously operated according to required electric power to obtain high output.

In such a vehicle, a technique for improving power generation efficiency by adjusting operation timing and output of each of the plurality of fuel cell systems has been developed.

For example, JP 2022-034394 A discloses a technique for optimizing the power generation efficiency of the entire system by changing outputs between fuel cell systems such that the number of fuel cell systems to be operated is changed according to the required power, and when a plurality of fuel cell systems are simultaneously operated, some of the fuel cell systems are operated at the output near the optimum efficiency, for example, while other fuel cell systems are operated at the output near the minimum output at which stable power generation is allowed.

### CITATION LIST

### Patent Literature

Patent Literature 1: JP 2022-034394 A

### SUMMARY

As in the above-described conventional technique, in a system in which a plurality of fuel cell systems are operated at different outputs, there is a difference in degrees of deterioration between the fuel cell systems, and as a result, there may be a problem that the life of the entire system is shortened or the frequency of maintenance is increased. Therefore, from the viewpoint of equalizing degradation between the fuel cell systems, it is attempted to equalize outputs between the fuel cell systems as much as possible. In this case, for example, the outputs are equalized by setting a target power generation amount of each of N fuel cell systems with respect to a required power generation amount P for the entire fuel cell system to be operated to P/N.

Here, normally, in a fuel cell system, a lower limit value and an upper limit value are set for an output (power generation amount) during operation, and control is performed such that the operation is performed within a range of the limit values. The lower limit value (lower limit power value) of the output is determined by deterioration characteristics or the like determined by the design of the fuel cell system, and usually does not significantly change throughout the life of the system. On the other hand, the upper limit value (upper limit power value) of the output can change according to the temperature of the fuel cell and the like even in the normal state, and can greatly decrease due to deterioration or failure of the fuel cell.

In the case of the power generation system that evenly distributes the required power generation amount to each of the plurality of fuel cell systems, for example, when the upper limit power value of a certain fuel cell system falls below the evenly distributed target power generation amount due to the occurrence of failure or the like, it is necessary to perform control to redistribute the excessive power generation amount to the other fuel cell systems.

FIG. 7 is a diagram illustrating an example of redistribution control at the time of failure in the power generation system that evenly distributes the required power generation amount. In this example, four fuel cell systems (FCS 1-4) are simultaneously used. Since the required power generation amount is evenly distributed to the four systems, 25% of the required power generation amount is allocated as the target power generation amount to each system, but the upper limit power value of two of the four systems (FCS 1 and FCS 2) is lower than that the normal time and thus lower than the target power generation amount. In this case, since the equal distribution becomes impossible, the redistribution control is executed, and the power generation amount exceeding the upper limit power value is equally distributed to the remaining two systems (FCS 3 and FCS 4). As a result, since the target power generation amount allocated to the FCS 3 exceeds the upper limit power value, the redistribution control is executed again, and the exceeding power generation amount is distributed to the FCS 4.

As described above, in the power generation system that performs the control to evenly distribute the required power generation amount among a plurality of fuel cell systems, when the upper limit power value decreases due to failure, deterioration, or the like in any of the plurality of fuel cell systems, the required power generation amount may not be evenly distributed. In the control of redistribution of the power generation amount exceeding the upper limit power value to other fuel cell systems, there is a problem that the control of redistribution becomes complicated and a calculation load increases depending on the number of fuel cell systems that are used, the number of fuel cell systems whose output is limited, the degree of output limitation, and the like.

The present invention has been made to solve such a problem, and an object of the present invention is to provide a fuel cell power generation control system capable of efficiently determining a target power generation amount, when output limitation occurs in any of a plurality of fuel cell systems, amount of each fuel cell system with a small calculation load. This ultimately contributes to energy efficiency.

In order to achieve this object, a fuel cell power generation control system according to claim 1 of the present invention includes: a plurality of fuel cell systems each including a fuel cell capable of generating electric power by a reaction of a fuel gas and an oxidant gas; a required power generation amount acquisition unit configured to acquire a required power generation amount for the plurality of fuel cell systems; a limit value acquisition unit configured to acquire an output limit value for the fuel cell of each of the plurality of fuel cell systems; and a power generation amount determination unit configured to determine a target power generation amount for each of the plurality of fuel cell systems, wherein the power generation amount determination unit determines the target power generation amount based on the required power generation amount and the output limit value.

In the fuel cell power generation control system, the limit value acquisition unit acquires an output limit value for the fuel cell of each of the plurality of fuel cell systems, and the power generation amount determination unit determines the target power generation amount in each of the plurality of fuel cell systems based on the required power generation amount and the output limit value.

Therefore, even when the output limitation occurs due to a failure, deterioration, or the like in any of the plurality of fuel cell systems, the target power generation amount of each fuel cell system can be determined based on the required power generation amount and the output limitation value in consideration of the output limitation in advance.

As a result, the target power generation amount of each of the fuel cell systems can be efficiently determined with a small calculation load without repeating the calculation for redistribution many times depending on the number of the fuel cell system in which the output limitation occurs and the degree of the output limitation.

According to claim 2 of the present invention, the fuel cell power generation control system according to claim 1 is configured such that the limit value acquisition unit acquires, as the output limit value, an upper limit power value and a lower limit power value, the upper limit power value being an upper limit value of an output of each of the fuel cells, the lower limit power value being a lower limit value of an output in each of the fuel cells, and the power generation amount determination unit calculates, as a power-generatable width, a difference between the upper limit power value and the lower limit power value for each of the fuel cells, subsequently calculates, as a power-generatable ratio of the each of the fuel cells, a ratio of the power-generatable width in the each of the fuel cells to a sum of the power-generatable widths for all of the fuel cells, and determines the target power generation amount for the each of the plurality of fuel cell systems based on the required power generation amount and the power-generatable ratio.

According to this configuration, the power generation amount determination unit calculates the difference between the upper limit power value and the lower limit power value for each of the fuel cells of the plurality of fuel cell systems as the power-generatable width for the each of the fuel cells. Further, the ratio of the power-generatable width of the each of the fuel cells to the sum of the power-generatable widths for all of the fuel cells is calculated as the power-generatable ratio of the each of the fuel cells. The target power generation amount for the each of the plurality of fuel cell systems is determined based on the calculated power-generatable ratio for the each of the fuel cells and the required power generation amount.

As described above, the power generation capability of each fuel cell is acquired in advance as the power-generatable ratio for all of the fuel cells, and the target power generation amount is determined based on the power-generatable ratio and the required power generation amount, and therefore, for example, in a state where all the fuel cells operate normally and the power-generatable ratios of the fuel cells are substantially equal to each other, the required power generation amount can be substantially evenly distributed to all of the fuel cells. In addition, for example, even in a case where output limitation occurs due to failure, deterioration, or the like in any of the fuel cells, it is possible to calculate the power-generatable ratio according to the degree of the output limitation and determine the target power generation amount according to the power-generatable ratio. Therefore, it is possible to determine the target power generation amount so as not to exceed the upper limit power value of each of the fuel cells efficiently with a small calculation load.

According to claim 3 of the present invention, the fuel cell power generation control system according to claim 2 is configured such that the power generation amount determination unit calculates, as a distributed power generation amount for each of the fuel cells, a value obtained by multiplying a value obtained by subtracting a total value of the lower limit power values for all of the fuel cells from the required power generation amount by the power-generatable ratio for the each of the fuel cells, and sets, as a target power generation amount for the each of the plurality of fuel cell systems, a value obtained by adding the lower limit power value and the distributed power generation amount for the each of the fuel cells.

According to this configuration, the power generation amount determination unit calculates, as the distributed power generation amount for each of the fuel cells, a value obtained by multiplying the value obtained by subtracting the total value of the lower limit power values for all of the fuel cells from the required power generation amount, that is, the value of the power generation amount that can be freely distributed to each fuel cell in the required power generation amount, by the power-generatable ratio for the each of the fuel cells. Then, a total value of the lower limit power value and the distributed power generation amount for each of the fuel cells is determined as the target power generation amount of the fuel cell system including the fuel cell.

In this way, the distributed power generation amount for each fuel cell is calculated by multiplying the value obtained by subtracting the sum of the lower limit power values of all the fuel cells from the required power generation amount in advance by the power-generatable ratio, and the sum of the distributed power generation amount and the lower limit power value is set as the target power generation amount in the fuel cell system. As a result, the target power generation amount that more accurately reflects the power-generatable ratio of each fuel cell can be determined, and therefore the target power generation amount of each fuel cell system can be efficiently determined with a small calculation load.

A method for controlling a fuel cell power generation control system according to claim 4 of the present invention is a method of controlling a fuel cell power generation control system, the system including: a plurality of fuel cell systems each including a fuel cell capable of generating electric power by a reaction of a fuel gas and an oxidant gas; a required power generation amount acquisition unit configured to acquire a required power generation amount for the plurality of fuel cell systems; and a limit value acquisition unit configured to acquire an output limit value for the fuel cell of each of the plurality of fuel cell systems; and a power generation amount determination unit configured to determine a target power generation amount for each of the plurality of fuel cell systems, wherein the power generation amount determination unit executes control for determining the target power generation amount based on the required power generation amount and the output limit value.

According to the method for controlling a fuel cell power generation control system, the power generation amount determination unit executes the control for determining the target power generation amount for each of the plurality of fuel cell systems based on the required power generation amount and the output limit value.

Therefore, even when the output limitation occurs due to a failure, deterioration, or the like in any of the plurality of fuel cell systems, the target power generation amount of each fuel cell system can be determined based on the required power generation amount and the output limitation value in consideration of the output limitation in advance.

As a result, the target power generation amount of each of the fuel cell systems can be efficiently determined with a small calculation load without repeating the calculation for redistribution many times depending on the number of the fuel cell system in which the output limitation occurs and the degree of the output limitation.

### BRIEF DESCRIPTION OF DRAWINGS

FIG. 1 is a diagram illustrating an example of a schematic configuration of a fuel cell vehicle on which a power generation control system according to an embodiment is mounted;

FIG. 2 is a diagram illustrating an example of a schematic configuration of an FC system according to a first embodiment;

FIG. 3 is a flowchart illustrating control processing for determining a target power generation amount in the power generation control system according to the embodiment;

FIG. 4 is a diagram for explanation of target power generation amount determination by target power generation amount determination control in a normal state;

FIG. 5 is a diagram for explanation of target power generation amount determination by target power generation amount determination control at the time of output limitation;

FIGS. 6A-6C are tables comparing procedures of target power generation amount determination in the embodiment and in the conventional technique;

FIG. 7 is a diagram for explanation of the procedure of target power generation amount determination in the conventional technique that evenly distributes a required power generation amount; and

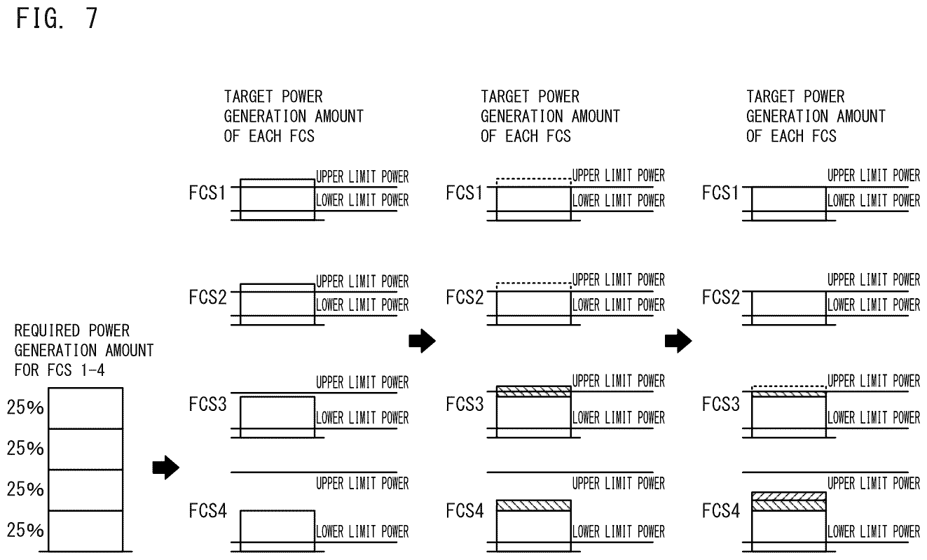

FIG. 8 is a diagram illustrating an example of a schematic configuration of an FC system according to a second embodiment.

### DETAILED DESCRIPTION

Hereinafter, a preferred embodiment of a fuel cell power generation control system of the present invention will be described in detail with reference to the drawings. A fuel cell power generation control system according to a first embodiment exemplified herein is mounted on a fuel cell vehicle, and electric power generated by the fuel cell is used as one of power sources of the fuel cell vehicle. The fuel cell vehicle may be a two-wheeled vehicle, a three-wheeled vehicle, a four-wheeled vehicle, or the like, and may be a large vehicle on which a plurality of fuel cell systems described later can be mounted. Note that a configuration described below exemplifies the present invention, and the present invention is not limited to this configuration.

### <Schematic Configuration of Fuel Cell Vehicle 100>

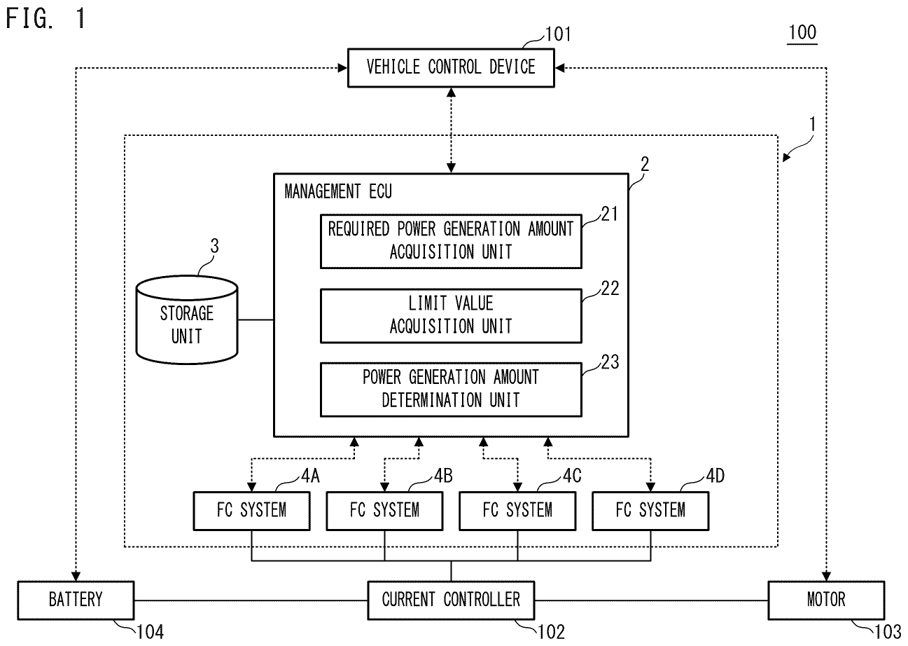

FIG. 1 is a schematic configuration diagram of a fuel cell vehicle 100 on which a fuel cell power generation control system 1 according to the first embodiment is mounted. The fuel cell vehicle 100 is a fuel cell electric vehicle, for example, and as shown in the drawing, the fuel cell vehicle 100 includes a vehicle control device 101, a current controller 102, a motor 103, a battery 104, a management electronic control unit (ECU) 2, a storage unit 3, and a fuel cell (FC) system 4.

In the example of FIG. 1, four FC systems 4A, 4B, 4C, and 4D are illustrated, but the number of FC systems 4 mounted is not limited to this example. When not individually distinguished, the FC systems may be simply referred to as “FC system 4”. The FC system 4 and the management ECU 2 constitute the power generation control system 1 according to the present embodiment. Here, the vehicle control device 101 may be included as a part of the power generation control system.

The motor 103 is, for example, a three-phase AC motor, and is driven using electric power supplied from the FC system 4 or the battery 104 via the current controller 102 as a power source. A rotor of the motor 103 is connected to a driving wheel (not illustrated), and the motor 103 outputs a driving force used for traveling of the fuel cell vehicle 100 to the driving wheel under the control of the vehicle control device 101. In addition, the motor 103 performs regenerative power generation using kinetic energy of the vehicle at the time of deceleration of the vehicle.

The battery 104 is, for example, a secondary battery such as a lithium ion battery. The battery 104 stores electric power generated by the FC system 4 or the motor 103, and supplies electric power for traveling of the fuel cell vehicle 100 to the motor 103 under the control of the vehicle control device 101. In addition, when the FC system 4 is activated, power for driving an auxiliary machine of the FC system 4 is supplied. In addition, after starting of the activation of the FC system 4, electric power is supplied to cover a gap until the power generated by the FC system 4 reaches the required power.

The battery 104 is provided with sensors such as a current sensor, a voltage sensor, and a temperature sensor (that are not illustrated), and outputs a current value, a voltage value, a temperature, and the like detected by these sensors to the vehicle control device 101.

The vehicle control device 101 is, for example, an ECU configured by a microcomputer including a CPU, a RAM, a ROM, an I/O interface (any of these are not illustrated), and the like, and integrally controls the traveling of the fuel cell vehicle 100, the operation of an in-vehicle device (not illustrated), and the like.

The vehicle control device 101 controls the supply of the electric power stored in the battery 104 and electric power generated by the FC system 4 according to the required electric power from the fuel cell vehicle 100. The required power from the fuel cell vehicle 100 is a total load power required for driving and operating the motor 103, a brake device and various sensors (not illustrated), other in-vehicle devices, auxiliary machines, and the like.

In addition, the vehicle control device 101 may perform travelling control of the fuel cell vehicle 100, powering/regenerative drive control of the motor 103, and charge/discharge control of the battery 104.

The management ECU 2 is, for example, an ECU configured by a microcomputer including a CPU, a RAM, a ROM, an I/O interface (any of these are not illustrated), and the like, and integrally controls a plurality of FC systems 4 (FC systems 4A, 4B, 4C, and 4D). The management ECU 2 includes a plurality of communication interfaces corresponding to the number of the plurality of FC systems 4, and each of the communication interfaces communicates with the FC system 4 of a corresponding connection destination.

As described later, the management ECU 2 acquires a power supply instruction for the FC system 4 and the information on the required power generation amount from the vehicle control device 101, and determines the power generation amount of each FC system based on the power supply instruction and the information. The management ECU 2 includes functional units such as a required power generation amount acquisition unit 21, a limit value acquisition unit 22, and a power generation amount determination unit 23. Details of these functional units will be described later.

The storage unit 3 is realized by hardware such as a hard disk drive (HDD), a flash memory, an electrically erasable programmable read only memory (EEPROM), a read only memory (ROM), or a random access memory (RAN). The storage unit 3 stores, for example, state information indicating a state of each FC system to be described later.

Each of the plurality of FC systems 4 includes a fuel cell. A fuel cell is a cell that generates power by an electrochemical reaction between a fuel gas supplied to an anode and an oxidant gas supplied to a cathode. In the present embodiment, a hydrogen gas is used as the fuel gas, and air containing oxygen is used as the oxidant gas.

As described later, the FC system 4 generates power according to a target power generation amount determined by the control of the management ECU 2, and supplies the generated power to the motor 103 or the battery 104 via the current controller 102 under the control of the vehicle control device 101.

### <Configuration of FC System 4>

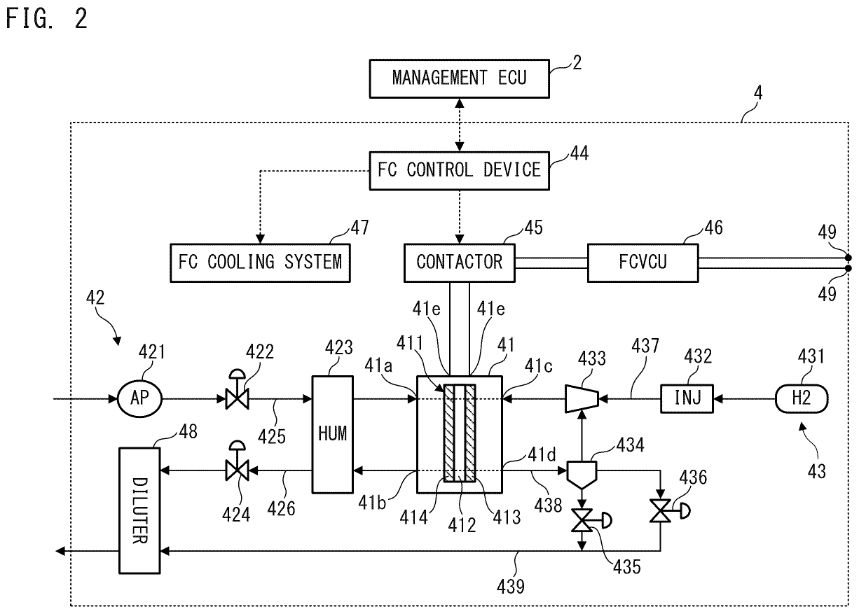

A specific configuration of the FC system 4 will be described with reference to FIG. 2. FIG. 2 is a diagram illustrating an example of a schematic configuration of an FC system according to the embodiment. The configuration illustrated in FIG. 2 is applicable to each of the plurality of FC systems 4 mounted on fuel cell vehicle 100. Note that the configuration described below is merely an example, and any configuration may be used as long as it is a system configuration in which power is generated by an anode and a cathode.

The FC system 4 illustrated in FIG. 2 includes an FC stack (fuel cell) 41, an oxidant gas supply device 42, a hydrogen gas supply device 43, an FC control device 44, a contactor 45, a fuel cell voltage control unit (FCVCU) 46, an FC cooling system 47, and a diluter 48.

The FC stack 41 is a structure in which a plurality of power generation cells 411 are stacked. The FC stack 41 is provided with an oxidant gas inlet 41a, an oxidant gas outlet 41b, a hydrogen gas inlet 41c, a hydrogen gas outlet 41d, and electrodes 41e and 41e.

Each of the power generation cells 411 of the FC stack 41 has a configuration in which a solid polymer electrolyte membrane (hereinafter, also simply referred to as an electrolyte membrane) 412 made of, for example, a cation exchange membrane such as a thin film of perfluorosulfonic acid containing moisture is sandwiched between an anode electrode 413 and a cathode electrode 414. As the electrolyte membrane 412, in addition to a fluorine-based electrolyte, a hydrocarbon-based electrolyte or the like can be used.

To the anode electrode 413, the hydrogen gas which is a fuel gas containing hydrogen is supplied from the hydrogen gas supply device 43. The air which is an oxidant gas containing oxygen is supplied from the oxidant gas supply device 42 to the cathode electrode 414. The hydrogen supplied to the anode electrode 413 is ionized by a catalytic reaction on an anode catalyst (not illustrated), and the generated hydrogen ions pass through the electrolyte membrane 412 and move to the cathode electrode 414. Electrons emitted with the ionization of hydrogen move to an external circuit via the electrode 41e to generate a current, and thus power is generated. The hydrogen ions moved from the anode electrode 413 to the cathode electrode 414 react with oxygen supplied to the cathode electrode 414 to generate water.

The oxidant gas supply device 42 includes an air pump 421 that compresses air from atmosphere and supplies the compressed air to the FC stack 41, and the air pump 421 is disposed in an air supply flow path 425. The air pump 421 is driven and controlled by the FC control device 44.

The air supply flow path 425 is provided with a humidifier 423. The air supply flow path 425 communicates with the oxidant gas inlet 41a of the FC stack 41.

The oxidant gas outlet 41b communicates with an air discharge flow path 426 passing through the humidifier 423. The humidifier 423 recovers moisture from the reacted air (including the reacted gas and the off-gas) discharged from the oxidant gas outlet 41b and passing through the air discharge flow path 426, and humidifies the air passing through the air supply flow path 425 using the recovered moisture. As a result, the electrolyte membrane 412 in each power generation cell 411 of the FC stack 41 can be maintained at a humidity suitable for power generation.

On the downstream side of the air pump 421 in the air supply flow path 425, a supply-side sealing valve 422 is provided. The supply-side sealing valve 422 is opened and closed under the control of the FC control device 44, and switches between opening and closing of the air supply flow path 425.

A discharge-side sealing valve 424 is provided in the air discharge flow path 426. The discharge-side sealing valve 424 is opened and closed under the control of the FC control device 44, and switches between opening and closing of the air discharge flow path 426. The diluter 48 to be described later is connected to the downstream side of the discharge-side sealing valve 424.

The hydrogen gas supply device 43 includes a hydrogen tank 431 that stores high-pressure hydrogen gas. The hydrogen tank 431 communicates with the hydrogen gas inlet 41c of the FC stack 41 via the hydrogen supply flow path 437. In the hydrogen supply flow path 437, an injector 432 and an ejector 433 are provided in series.

An opening degree of the injector 432 is controlled by the FC control device 44, and a flow rate and supply timing of the hydrogen gas supplied to the FC stack 41 are defined. When an interior of the ejector 433 has a negative pressure, the ejector 433 sucks the off-gas discharged from the hydrogen gas outlet 41d to an off-gas flow path 438 to cause the off-gas to circulate through the hydrogen supply flow path 437.

The off-gas flow path 438 communicates with the hydrogen gas outlet 41d of the FC stack 41, and a gas-liquid separator 434 is connected to the off-gas flow path 438.

The gas-liquid separator 434 separates the off-gas discharged from the hydrogen gas outlet 41d of the FC stack 41 into a gas component and a liquid component. The liquid component separated from the off-gas is discharged to a purge flow path 439 through a drain valve 435 which is opened and closed by the FC control device 44. In addition, a part of the gas component separated from the off-gas is recirculated through the ejector 433, and the other part is discharged to the purge flow path 439 through the purge valve 436 which is opened and closed by the FC control device 44. The purge flow path is connected to the diluter 48.

The diluter 48 mixes the reacted air (including the reacted gas and the off-gas) discharged from the oxidant gas outlet 41b of the FC stack 41 with the off-gas discharged from the hydrogen gas outlet 41d of the FC stack 41, dilutes the gas so that the hydrogen concentration is decreased down to a specified value or less, and then discharges the gas outside.

The contactor 45 is provided between the anode electrode 413 and the cathode electrode 414 of the FC stack 41 and the FCVCU 46, and switches on/off of the electrical connection between the FC stack 41 and the FCVCU 46 based on the control of the FC control device 44.

The FCVCU 46 is a step-up DC-DC converter. The FCVCU 46 is disposed between the anode electrode 413 and the cathode electrode 414 of the FC stack 41 via the contactor 45 and an electrical load outside the FC system 4. The FCVCU 46 boosts the voltage of an output terminal 49 connected to the electrical load side to the target voltage determined by the FC control device 44. The FCVCU 46 boosts the voltage output from the FC stack 41 to a target voltage, and outputs the target voltage to the output terminal 49.

The FC control device 44 is an ECU constituted by a microcomputer including a CPU, a RAM, a ROM, an I/O interface (any of these are not illustrated), and the like, and is provided in each of the FC systems 4.

The FC control device 44 is configured to be able to acquire information regarding a state of the FC system 4 to which the FC control device 44 itself belongs based on detection values of various sensors (not illustrated). The FC control device 44 acquires the information regarding the state of the FC system 4 continuously or in response to an instruction from the management ECU 2, and transmits the acquired information to the management ECU 2.

Examples of the acquired state of the FC system include a current power generation state, a power generation amount, a power generation time, the number of times of starting (or the number of times of stopping), and the like, and in particular information on an output limitation of the FC stack 41. The information on the output limitation includes a lower limit power value and an upper limit power value to be described later.

Further, the FC control device 44 controls start and end of power generation, a power generation amount, and the like in the FC system 4 according to the control of the management ECU 2. In addition, the FC control device 44 performs opening/closing control of various valves in the FC system 4, drive control of various auxiliary machines (such as the air pump 421), and the like. The FC control device 44 also performs control related to temperature adjustment for the FC stack 41 using the FC cooling system 47.

Moreover, the FC control device 44 may perform power feeding control for the fuel cell vehicle 100 in cooperation with the management ECU 2 and the vehicle control device 101.

The FC cooling system 47 cools the FC stack 41 under the control of the FC control device 44. For example, the FC cooling system 47 cools the FC stack 41 by causing a refrigerant such as pure water or ethylene glycol to circulate in a refrigerant flow path (not illustrated) provided in the FC stack 41.

### <Power Generation Operation of FC System 4>

A power generation operation of the FC system 4 (a power generation operation in the fuel cell stack 41) constituted as described above will be described below.

The oxidant gas supply device 42 supplies air as oxidant gas to the air supply flow path 425 via the air pump 421. The air is humidified through the humidifier 423 and then supplied to the fuel cell stack 41 from the oxidant gas inlet 41a.

On the other hand, the hydrogen gas supply device 43 supplies hydrogen gas from the hydrogen tank 431 to the hydrogen supply flow path 437 based on the opening degree control of the injector 432 by the FC control device 44. This hydrogen gas passes through the ejector 433 and is then supplied from the hydrogen gas inlet 41c to the FC stack 41.

The air supplied from the oxidant gas inlet 41a to the FC stack 41 is supplied to the cathode electrode 414 of each power generation cell 411, and the hydrogen gas supplied from the hydrogen gas inlet 41c to the FC stack 41 is supplied to the anode electrode 413 of each power generation cell 411. As a result, in each power generation cell 411, hydrogen and oxygen in the air are consumed by an electrochemical reaction, and power generation is performed.

The electric power generated by the power generation is supplied to the battery 104 or the motor 103 through the current controller 102 under the control of the FC control device 44.

The air after the reaction (including the reacted gas and the off-gas) in the cathode electrode 414 of each power generation cell 411 is discharged from the oxidant gas outlet 41b to the air discharge flow path 426. Moisture in the discharged air is recovered when passing through the humidifier 423, and then the discharged air is introduced into the diluter 48. As described above, the moisture recovered by the humidifier 423 is used for humidifying the air passing through the air supply flow path 425 to adjust the humidity of the electrolyte membrane 412.

The hydrogen gas after the reaction at the anode electrode 413 of each power generation cell 411 is discharged as an off-gas (partially consumed fuel gas) from the hydrogen gas outlet 41d to the off-gas flow path 438. The discharged off-gas is introduced into the gas-liquid separator 434 from the off-gas flow path 438 to separate liquid moisture, and then either recirculated via the ejector 433 or discharged outside through the purge flow path 439.

During the execution of the series of power generation operations described above, the FC cooling system 47 is driven according to the temperature of the FC stack 41 based on the control of the FC control device 44, and the FC stack 41 is cooled.

### <Configuration of Management ECU 2>

Next, a configuration of a control system of the management ECU 2 will be described. As illustrated in FIG. 1, the management ECU 2 includes the required power generation amount acquisition unit 21, the limit value acquisition unit 22, and the power generation amount determination unit 23. Each of these functional units 21-23 is realized by, for example, a hardware processor such as a CPU of the management ECU 2 reading and executing a program (software). Such a program may be stored in a ROM or a RAM included in the management ECU 2, or may be stored in a storage device (a storage device including a non-transitory storage medium such as an HDD or a flash memory) constituting the storage unit 3.

The required power generation amount acquisition unit 21 includes, for example, a communication interface unit that communicates with the vehicle control device 101. The required power generation amount acquisition unit 21 acquires, from the vehicle control device 101 via the communication interface unit, a command related to the required power generation amount for the plurality of FC systems 4 (for example, an amount of electric power obtained by excluding an amount of electric power supplied by the battery 104 from the required power generation amount that is required for the entire fuel cell vehicle 100).

The limit value acquisition unit 22 includes, for example, a plurality of communication interface units corresponding to the number of the plurality of FC systems 4. The limit value acquisition unit 22 acquires information, via these communication interface units, on the limit value of the power generation amount among information regarding various states output from each of the FC systems 4 at a predetermined timing or cycle. Examples of the limit value related to the power generation amount include an upper limit power value which is an upper limit value of the output (power generation amount) of each of the FC systems 4 and a lower limit power value which is a lower limit value of the output (power generation amount) of each of the FC systems 4. The limit value acquisition unit 22 stores the acquired information on the limit value of the power generation amount of each of the FC systems 4 in the storage unit 3.

Based on the required power generation amount for the FC system 4 acquired by the required power generation amount acquisition unit 21 and the information of the limit value of the power generation amount acquired by the limit value acquisition unit 22, the power generation amount determination unit 23 executes target power generation amount determination control to be described later, and thus determines a target power generation amount which is electric power to be generated by each of the FC systems 4.

### <Target Power Generation Amount Determination Control>

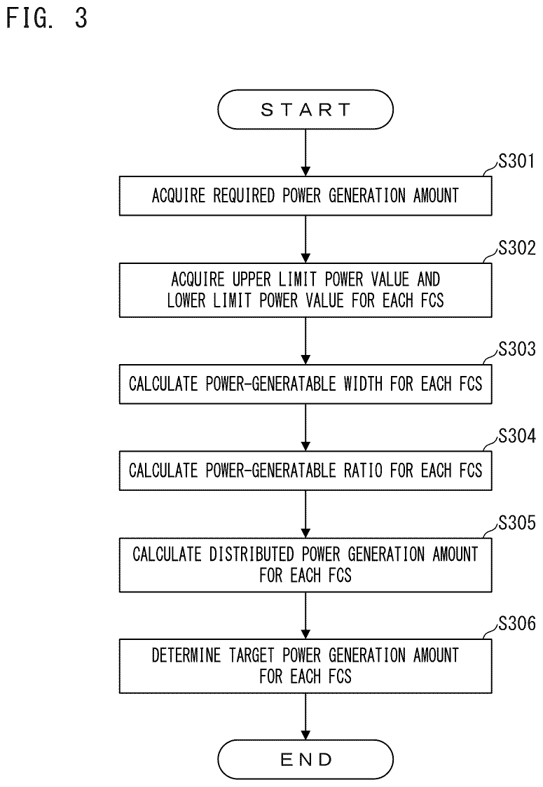

Next, target power generation amount determination control by the power generation control system 1 of the present embodiment will be described with reference to FIGS. 3 to 6. FIG. 3 is a flowchart illustrating control processing for determining a target power generation amount according to the present embodiment. This processing is repeatedly executed either at a predetermined timing or at a predetermined cycle during the power generation operation of the FC systems 4, for example.

In this control processing, first, the required power generation amount acquisition unit 21 of the management ECU 2 acquires the required power generation amount for the entire FC systems 4 (step 301 (indicated as “S301” in the drawings; the same shall apply hereinafter)). The required power generation amount may be for traveling of the fuel cell vehicle 100 or may be for driving and operating in-vehicle equipment and auxiliary machines.

After the required power generation amount is acquired, the limit value acquisition unit 22 acquires the upper limit power value and the lower limit power value as the limit values of the output of each of the FC systems 4 (step 302). In the processing of step 302, the limit value acquisition unit 22 may store the upper limit power value and the lower limit power value of each of the FC systems 4 that have been acquired in the storage unit 3 as the limit value information. Furthermore, the processing of step 302 may be repeatedly executed at a predetermined timing or cycle before step 301 is executed.

Subsequently, in subsequent steps 303 to 306, the power generation amount determination unit 23 determines the target power generation amount of each of the FC systems 4 based on the acquired required power generation amount and the acquired limit value information of each of the FC systems 4.

First, the power generation amount determination unit 23 calculates the power-generatable width for each of the FC systems 4 based on the upper limit power value and the lower limit power value of each of the FC systems 4 (step 303). The power-generatable width means a width (output width) of a value of electric power that can be generated by each of the FC systems 4, and, in the present embodiment, is calculated as a difference between the upper limit power value and the lower limit power value of each of the FC systems 4.

Next, based on the calculated power-generatable widths of the respective FC systems 4, a ratio of the power-generatable width of the individual FC systems 4 to the sum of the power-generatable widths of all the FC systems 4 is calculated as the power-generatable ratio in the FC system 4 (step 304). The calculated power-generatable ratio is an index indicating a ratio of a power generation amount that can be borne by the FC system 4.

Next, the power generation amount determination unit 23 calculates a value obtained by subtracting the total value of the lower limit power values in all the FC systems 4 from the acquired required power generation amount, that is, a value of the power generation amount that can be freely distributed to each of the FC systems 4 among the required power generation amount, and calculates a value obtained by multiplying the calculated value by the power-generatable ratio of each of the FC systems 4 as the distributed power generation amount for each of the FC systems 4 (step 305).

Then, the total value of the lower limit power value and the distributed power generation amount for each of the FC systems 4 is determined as the target power generation amount of the FC system 4 (step 306), and thereafter, this processing ends.

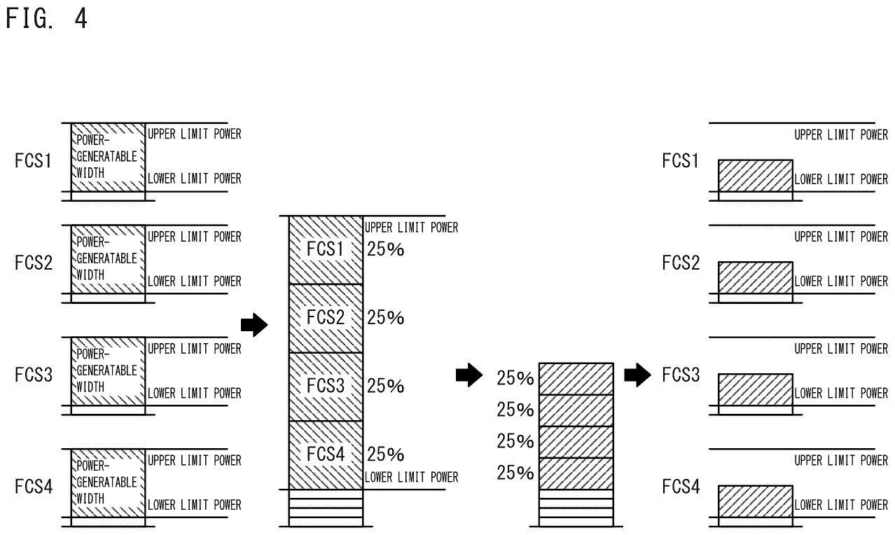

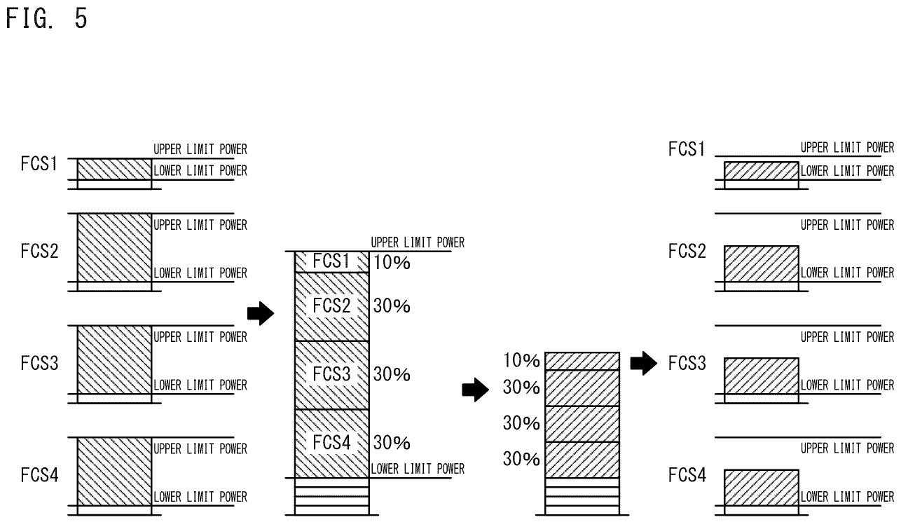

FIGS. 4 and 5 are diagrams for explanation for the determination of the target power generation amount by the target power generation amount determination control of the present embodiment, where FIG. 4 illustrates the determination of the target power generation amount in a normal state, and FIG. 5 illustrates the determination of the target power generation amount in a case where the output limitation occurs in a part of the FC systems 4.

Here, a flow of the determination of a target power generation amount in a normal state will be described with reference to FIG. 4. First, the power-generatable width is calculated based on the upper limit power value and the lower limit power value of each of the four FC systems 4 (FCS 1-4). Thereafter, the power-generatable widths of all the FC systems 4 are summed to calculate the entire power-generatable width, and then the power-generatable ratio of each of the FC systems 4 is calculated. In this example, since the FC systems 4 are operating normally (the upper limit power values are not limited), the power-generatable widths of the FC systems 4 are substantially equal, and thus the power-generatable ratios of the FC systems 4 are also equal. Here, since the four FC systems 4 are used, the power-generatable ratio of each of the FC systems 4 is 25%.

Subsequently, after the lower limit power values of the FC systems 4 are subtracted from the required power generation amount, the distributed power generation amount is calculated based on the calculated power-generatable ratio. Then, a value obtained by adding the lower limit power value to the calculated distributed power generation amount is determined as the target power generation amount of each of the FC systems 4.

As described above, when the upper limit power value of each of the FC systems 4 is not limited and the power-generatable widths are substantially equal, the target power generation amount of each of the FC systems 4 is similar to the case where the required power generation amount is evenly distributed according to the number of FC systems 4. In addition, since the target power generation amount for each of the FC systems 4 is determined based on the power-generatable ratio, the target power generation amount does not exceed the upper limit power value.

Next, a flow of the determination of a target power generation amount in a case where an output limitation occurs in one (FCS 1) of the four FC systems 4 will be described with reference to FIG. 5. First, similarly to the example of FIG. 4, the power-generatable width is calculated based on the upper limit power value and the lower limit power value of each of the four FC systems 4 (FCS 1-4), and then the power-generatable ratio is calculated. In this example, the upper limit power value of the FCS 1 decreases due to a factor such as failure or deterioration, and the power-generatable width decreases to about ⅓ of the normal time. Therefore, the power-generatable ratios of the FC systems 4 are 10% for the FCS 1 and 30% for the FCS 2-4.

Subsequently, similarly to the example of FIG. 4, the distributed power generation amount for each of the FC systems 4 is calculated based on the power-generatable ratio, and the target power generation amount is determined by adding the lower limit power value to the distributed power generation amount.

As described above, even when the output limitation occurs in any of the plurality of FC systems 4 and the upper limit power value decreases, the target power generation amount can be determined according to the power-generatable ratio of the FC system 4 in which the output limitation occurs, and therefore, the target power generation amount does not exceed the upper limit power value, and each of the FC systems 4 can be efficiently operated at an appropriate output.

In addition, in the target power generation amount determination control, since the target power generation amount of each of the FC systems 4 is determined by first calculating the power-generatable ratio of each of the FC systems 4 and distributing the required power generation amount according to the power-generatable ratio, the target power generation amount can be determined with a small calculation load without requiring recalculation or the like by the same control flow even when the number of the FC systems 4 to be used, the number of the FC systems 4 whose output is limited, the degree of output limitation, and the like change.

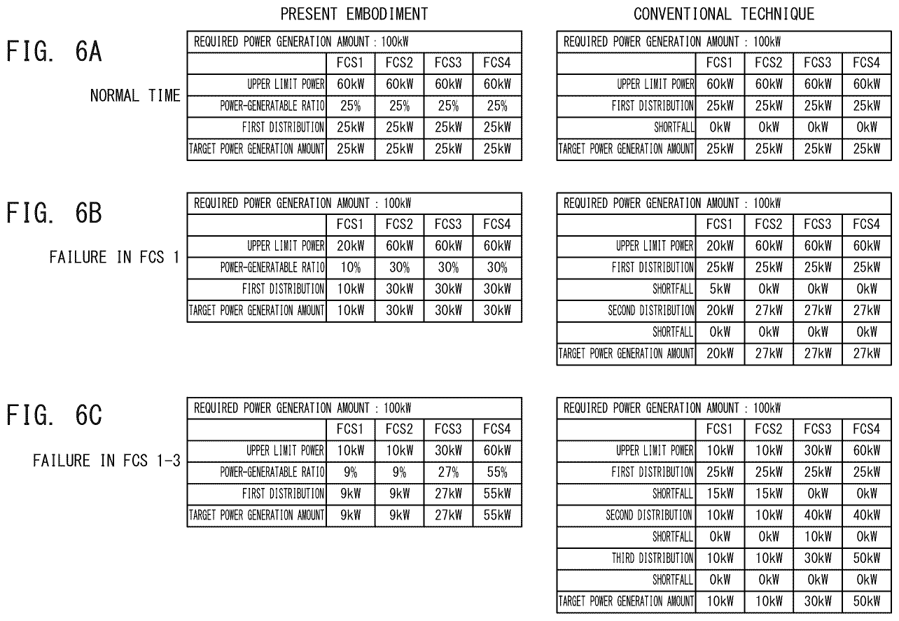

FIG. 6 is a table comparing the procedures of the target power generation amount determination of the target power generation amount determination control by the present embodiment and the conventional technique that evenly distributes the required power generation amount. In the example of FIG. 6, the required power generation amount for the entire FC systems 4 is 100 kW, the number of the FC systems 4 to be used is 4 (FCS 1-4), and the upper limit power in the normal state of each of the FC systems 4 is 60 kW. In order to avoid complication, the lower limit power value of each of the FC systems 4 is assumed to be 0 kW for convenience.

FIG. 6A illustrates a procedure of determining the target power generation amount at the normal time (when the output limitation is not generated in any of the FC systems 4).

First, in the conventional technique, since a value obtained by evenly distributing the required power generation amount by the number of the FC systems 4 is set as the target power generation amount, 100 kW/4=25 kW is the target power generation amount of each of the FC systems 4.

On the other hand, in the case of the present embodiment, as described above, the power-generatable ratio is calculated based on the power-generatable width (the upper limit power value−the lower limit power value) of each of the FC systems 4. Since all the power-generatable widths of the FC systems 4 are 60 kW, the power-generatable ratios are equal to each other and are 25%. Therefore, the target power generation amount of each of the FC systems 4 is the required power generation amount of 100 kW×0.25=25 kW.

As described above, in the determination of the target power generation amount at the normal time, the same result is obtained in the present embodiment and the conventional technique.

Next, with reference to FIG. 6B, a case where output limitation occurs in one (FCS 1) of the four FC systems 4 will be considered.

In the conventional technique, first, the required power generation amount of 100 kW is evenly distributed, and 25 kW is allocated to each of the FC systems 4. However, since the upper limit power value of the FCS 1 decreases to 20 kW, the target power generation amount exceeds the upper limit power value. Therefore, the excess power of 5 kW in the FCS 1 is equally distributed again by the FCS 2-4, and 25 kW+(5 kW/3)≈27 kW is set as the target power generation amount of the FCS 2-4. The target power generation amount of the FCS 1 is set to 20 kW which is the upper limit power value.

On the other hand, in the case of the present embodiment, similarly to the normal time, the power-generatable ratio is calculated based on the power-generatable width (the upper limit power value−the lower limit power value) of each of the FC systems 4. In this example, since the power-generatable width of the FCS 1 is reduced to 20 kW, the power-generatable ratio is 10% (20 kW/200 kW) for the FCS 1 and 30% (60 kW/200 kW) for the FCS 2-4. Therefore, the target power generation amounts of the FC systems 4 are the required power generation amount of 100 kW×0.1=10 kW in the FCS 1, and the required power generation amount of 100 kW×0.3=30 kW in the FCS 2-4.

As described above, in the case of the system in which the target power generation amount is determined by evenly distributing the required power generation amount as in the conventional technique, the redistribution control process may be required due to the output limitation in any of the FC systems 4, and the calculation load increases.

On the other hand, in the present embodiment, even when the output limitation occurs in any of the FC systems 4, the target power generation amount can be efficiently determined by the same control process as the normal time.

Finally, with reference to FIG. 6C, a case where output limitation occurs in a plurality (FCS 1-3) of the four FC systems 4 will be considered.

In the conventional technique, first, the required power generation amount of 100 kW is evenly distributed, and 25 kW is allocated to each of the FC systems 4. Since the upper limit power value of the FCS 1 and the FCS 2 is 10 kW, the target power generation amount exceeds the upper limit power value. Therefore, a total 30 kW of a power shortfall of 15 kW in the FCS 1 and a power shortfall of 15 kW in the FCS 2 is equally distributed again to the FCS 3-4. As a result, the upper limit power value of 10 kW is distributed to the FCS 1-2, and 25 kW+(30 kW/2)=40 kW is distributed to the FCS 3-4. However, since the upper limit power value of the FCS 3 is 30 kW, a power shortfall of 10 kW occurs, and it is necessary to perform distribution of an amount of the shortfall to the FCS 4 again. As a result, final target power generation amounts are set to 10 kW for the FCS 1-2, 30 kW for the FCS 3, and 50 kW for the FCS 4.

On the other hand, in the case of the present embodiment, similarly to the normal time, the power-generatable ratio is calculated based on the power-generatable width (the upper limit power value−the lower limit power value) of each of the FC systems 4. In this example, the power-generatable widths of the FCS 1 and the FCS 2 are reduced to 10 kW, and the power-generatable width of the FCS 3 is reduced to 30 kW. Therefore, the power-generatable ratio for the FCS 1-2 is 9% (10 kW/110 kW), for the FCS 3 is 27% (30 kW/110 kW), and for the FCS 4 is 55% (60 kW/110 kW). Therefore, the target power generation amounts of the FC systems 4 is the required power generation amount of 100 kW×0.09=9 kW for the FCS 1-2, the required power generation amount of 100 kW×0.27=27 kW for the FCS 3, and the required power generation amount of 100 kW×0.55=55 kW for the FCS 4.

As described above, in the case of the conventional technique, there is a case where redistribution control processing needs to be performed by a plurality of times depending on the number of the FC systems 4 in which the output limitation occurs and the degree of the output limitation, and in such a case, the calculation load becomes very large.

On the other hand, in the target power generation amount determination control of the present embodiment, even when the output limitation occurs in the plurality of FC systems 4 or the degree of the output limitation varies, it is possible to determine the appropriate target power generation amount by the same control process as the normal time efficiently with a small calculation load.

### <Effects of Present Embodiment>

Hereinafter, effects of the present embodiment will be described.

According to the present embodiment, in the target power generation amount determination control of the fuel cell power generation control system 1, the limit value acquisition unit 22 of the management ECU 2 acquires the output limit value of each of the FC systems 4, and the power generation amount determination unit 23 determines the target power generation amount of each of the FC systems 4 based on the required power generation amount and the output limit value. Therefore, even when the output limitation occurs due to a failure, deterioration, or the like in any of the plurality of FC systems 4, the target power generation amount of each of the FC systems 4 can be determined based on the required power generation amount and the output limitation value in consideration of the output limitation in advance.

As a result, the target power generation amount of each of the FC systems 4 can be determined efficiently with a small calculation load without changing the control flow or repeating the calculation for redistribution according to the number of the FC systems 4 in which the output limitation occurs or the degree of the output limitation.

In addition, the power generation amount determination unit 23 calculates the difference between the upper limit power value and the lower limit power value in (the FC stack 41 of) each of the plurality of FC systems 4 as a power-generatable width in the FC system 4. Further, a ratio of the power-generatable width of each of the FC systems 4 to the total value of the power-generatable widths of all the FC systems 4 is calculated as the power-generatable ratio in the FC system 4. Then, the target power generation amount in each of the FC systems 4 is determined based on the calculated power-generatable ratio and the required power generation amount.

As described above, the power generation capability of each FC system 4 is acquired in advance as the power-generatable ratio for all of the FC systems 4, and the target power generation amount is determined based on the power-generatable ratio and the required power generation amount, and therefore, for example, in a state where all the FC systems 4 operate normally and the power-generatable ratios of the FC systems 4 are substantially equal to each other, the required power generation amount can be substantially evenly distributed to all of the FC systems 4. In addition, for example, even in a case where output limitation occurs due to failure, deterioration, or the like in any of the FC systems 4, it is possible to calculate the power-generatable ratio according to the degree of the output limitation and determine the target power generation amount according to the power-generatable ratio. Therefore, it is possible to determine the target power generation amount so as not to exceed the upper limit power value of each of the FC systems 4 efficiently with a small calculation load.

Further, the power generation amount determination unit 23 calculates, as the distributed power generation amount for each of the FC systems 4, a value obtained by multiplying a value obtained by subtracting the total value of the lower limit power values in all the FC systems 4 from the required power generation amount, that is, a value of the power generation amount that can be freely distributed to each of the FC systems 4 among the required power generation amount, by the power-generatable ratio of each of the FC systems 4. Then, the total value of the lower limit power value and the distributed power generation amount for each of the FC systems 4 is determined as the target power generation amount of the FC system 4.

In this way, the distributed power generation amount for each of the FC systems 4 is calculated by multiplying the value obtained by subtracting the sum of the lower limit power values of all the FC systems 4 from the required power generation amount in advance by the power-generatable ratio, and the sum of the distributed power generation amount and the lower limit power value is set as the target power generation amount in the FC system 4. As a result, since the target power generation amount that more accurately reflects the power-generatable ratio of each of the FC systems 4 can be determined, the target power generation amount of each of the FC systems 4 can be efficiently determined with a small calculation load.

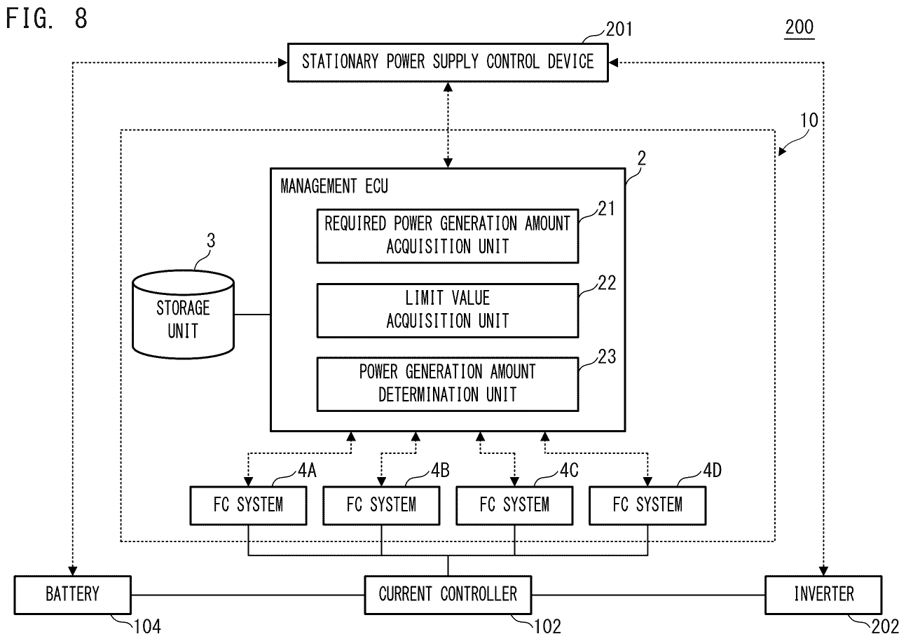

Next, a second embodiment in which the fuel cell power generation control system of the present invention is applied to a stationary facility such as a house or a factory will be described with reference to FIG. 8. In the following description, the same components as those of the fuel cell power generation control system 1 of the first embodiment are denoted by the same reference numerals, and the description thereof will be omitted.

As illustrated in FIG. 8, a fuel cell power generation control system 10 according to the second embodiment is installed in a stationary facility 200 such as a house or a factory, and functions as an auxiliary power supply facility that supplies a gap of power when, for example, power required by the stationary facility 200 exceeds power supplied by a main power supply facility.

A stationary power supply control device 201 is, for example, an ECU constituted by a microcomputer including a CPU, a RAM, a ROM, an I/O interface (any of these are not illustrated), and the like.

In the power generation control system 1 of the first embodiment, the vehicle control device 101 controls supply of the generated power and the like according to the electric power required by the fuel cell vehicle 100, but in the power generation control system 10 of the second embodiment, the stationary power supply control device 201 controls supply of the power stored in the battery 104 or the power generated by the FC system 4 according to the electric power required by a higher power supply management device (not illustrated).

The configuration and function of the management ECU 2 in the power generation control system 10 are similar to those in the power generation control system 1.

The management ECU 2 acquires a power supply instruction to the FC system 4 and the information on the required power generation amount from the stationary power supply control device 201, executes the target power generation amount determination control described above based on the instruction and the information, and determines the target power generation amount of each of the FC systems 4. The required power generation amount acquisition unit 21 of the management ECU 2 includes, for example, a communication interface unit that communicates with the stationary power supply control device 201, and acquires a command related to the required power generation amount for the plurality of FC systems 4 from the stationary power supply control device 201 via the communication interface.

The configuration and function of the FC system 4 in the power generation control system 10 are also similar to those in the power generation control system 1.

The FC system 4 generates power according to the target power generation amount determined by the target power generation amount determination control of the management ECU 2, and supplies the generated power to the battery 104 or an inverter 202 via the current controller 102 under the control of the stationary power supply control device 201. The inverter 202 converts DC power that has been supplied into AC power, and supplies the AC power to the stationary facility 200.

As described above, the fuel cell power generation control system of the present invention can also be applied to the stationary facility such as a house or a factory, and as in the case of being mounted on a moving body such as a vehicle, the target power generation amount of each of the FC systems 4 can be determined efficiently with a small calculation load without changing the control flow or without repeating calculation for redistribution according to the number of FC systems 4 in which the output limitation occurs or the degree of the output limitation.

It is to be noted that the present invention is not limited to the described embodiments, and can be implemented in various modes. In addition, the detailed configuration can be changed as appropriate within the scope of the gist of the present invention.

What is claimed is:

1. A fuel cell power generation control system comprising:
a plurality of fuel cell systems each including a fuel cell capable of generating electric power by a reaction of a fuel gas and an oxidant gas;
a required power generation amount acquisition unit configured to acquire a required power generation amount for the plurality of fuel cell systems;
a limit value acquisition unit configured to acquire an output limit value for the fuel cell of each of the plurality of fuel cell systems; and
a power generation amount determination unit configured to determine a target power generation amount for each of the plurality of fuel cell systems, wherein
the power generation amount determination unit determines the target power generation amount based on the required power generation amount and the output limit value.

2. The fuel cell power generation control system according to claim 1, wherein
the limit value acquisition unit acquires, as the output limit value, an upper limit power value and a lower limit power value, the upper limit power value being an upper limit value of an output of each of the fuel cells, the lower limit power value being a lower limit value of an output in each of the fuel cells, and
the power generation amount determination unit calculates, as a power-generatable width, a difference between the upper limit power value and the lower limit power value for each of the fuel cells, subsequently calculates, as a power-generatable ratio of the each of the fuel cells, a ratio of the power-generatable width in the each of the fuel cells to a sum of the power-generatable widths for all of the fuel cells, and determines the target power generation amount for the each of the plurality of fuel cell systems based on the required power generation amount and the power-generatable ratio.

3. The fuel cell power generation control system according to claim 2, wherein
the power generation amount determination unit calculates, as a distributed power generation amount for each of the fuel cells, a value obtained by multiplying a value obtained by subtracting a total value of the lower limit power values for all of the fuel cells from the required power generation amount by the power-generatable ratio for the each of the fuel cells, and sets, as a target power generation amount for the each of the plurality of fuel cell systems, a value obtained by adding the lower limit power value and the distributed power generation amount for the each of the fuel cells.

4. A method of controlling a fuel cell power generation control system, the system including:
a plurality of fuel cell systems each including a fuel cell capable of generating electric power by a reaction of a fuel gas and an oxidant gas;
a required power generation amount acquisition unit configured to acquire a required power generation amount for the plurality of fuel cell systems; and
a limit value acquisition unit configured to acquire an output limit value for the fuel cell of each of the plurality of fuel cell systems; and
a power generation amount determination unit configured to determine a target power generation amount for each of the plurality of fuel cell systems, wherein
the power generation amount determination unit executes control for determining the target power generation amount based on the required power generation amount and the output limit value.
